(19) United States
(12) Patent Application Publication
(10) Pub. No.: US 2015/0211439 A1
(43) Pub. Date: Jul. 30, 2015

(54) HEAT ENGINE AND THERMODYNAMIC CYCLE FOR CONVERTING HEAT INTO USEFUL WORK

(71) Applicant: Istvan Majoros, Zug (CH)

(72) Inventor: Istvan Majoros, Zug (CH)

(21) Appl. No.: 14/419,442

(22) PCT Filed: Aug. 6, 2013
(86) PCT No.: PCT/EP2013/066457

§ 371 Date: Feb. 3, 2015

(30) Foreign Application Priority Data
Aug. 6, 2012 (DE) 10 2012 213 878.1

(51) Int. Cl. F02G 1/044; F02G 1/055

(52) U.S. Cl. CPC F02G 1/0445; F02G 1/055

(57) ABSTRACT

Heat engine (1) for converting heat into useful work, comprising a first storage arrangement (2A) for a working gas, wherein said storage arrangement (2A) is divided into a first cold chamber (3A) and a first warm chamber (4A), and a first movable piston arrangement (5A) is configured in such a way that it changes the overall volume of the first storage arrangement (2A) and presses the working gas to and fro between the two first chambers (3A, 4A), characterized in that the heat engine (1) comprises a second storage arrangement (2B) for the working gas, wherein said second storage arrangement (2B) is divided into a second cold chamber (3B) and a second warm chamber (4B), and a second movable piston arrangement (5B) is configured in such a way that it changes the overall volume of the second storage arrangement (2B) and presses the working gas to and fro between the two second chambers (3B, 4B), and that a connection (6) between the first and the second storage arrangement (2A, 2B) is provided for a part quantity of the working gas to be exchanged between the two storage arrangements (2A, 2B) at least during a predefined constellation of the two piston arrangements (5A, 5B).

The invention relates to a heat engine for converting heat into useful work according to the features of the preamble of claim 1 and a thermodynamic cycle.

Heat engines are typically used for converting heat into useful work that can be used, for example, to drive a generator or a vehicle. Fuel is there burnt either inside or outside of the heat engine and the thermal energy released thereby is converted into mechanical work.

Internal combustion engines represent a group of heat engines. A mixture of air and fuel is there, for example, in a cylinder in a diesel engine so heavily compressed by a piston that it self-ignites. The energy thus released causes an expansion of the gas and thereby a force onto the piston, which can then perform mechanical work. After expansion of the gas is completed, it is discharged as exhaust gas to the environment and the residual heat contained therein can no longer be used.

Other representatives of heat engines are hot air engines, such as a Stirling motor. The motor is there supplied heat from the outside, for example, by external combustion or a solar system. An enclosed working gas is located within the motor and supplied heat and passes a thermodynamic cycle for converting heat into useful work.

Such heat engines commonly comprise a storage arrangement for a working gas that is divided into a cold and a warm chamber. The working gas is by a movable piston arrangement pressed to and fro between the two chambers and at the same time changes the overall volume of the storage arrangement. The overall volume is variable, for example, by the movement of a working piston that transfers the work performed by the working gas work as useful work.

Such devices have the drawback that the degree of efficiency in the internal combustion engines is reduced by the fact that the waste heat of the exhaust gas can not be converted into mechanical work. On the other hand, the heat engines comprise a relatively complex mechanism, which can not reproduce the ideal cycle, whereby the degree of efficiency is there reduced as well.

The object of the invention is to provide a heat engine and a thermodynamic cycle for converting heat into useful work which allow for low complexity of mechanically moving elements and for a high degree of efficiency.

The invention provides a heat engine for converting heat into useful work according to the features of the preamble of claim 1 with the features of the characterizing part, according to which the heat engine comprises a second storage arrangement for the working gas, where the latter is divided into a second cold and a second warm chamber, and a second movable piston arrangement is configured in such a way that it changes the overall volume of the second storage arrangement and presses the working gas to and fro between the two second chambers, and that a connection between the first and the second storage arrangement is provided for a part quantity of the working gas to be exchanged between the two storage arrangements at least during a predefined constellation of the two piston arrangements.

Due to the fact that the heat engine according to the invention provides a first storage arrangement with a first movable piston arrangement which presses the working gas contained therein to and fro between the two first chambers and additionally comprises a second storage arrangement in which a second movable storage arrangement presses the working gas to and fro between the two second chambers, and a connection between the first and the second storage arrangement is additionally provided for exchanging a part quantity of the working gas between the two storage arrangements during a predefined constellation of the two piston arrangements, pressure equalization between the two storage arrangements is achieved. Due to the pressure equalization, a mass Δm of the working gas is transferred from the one storage arrangement with the higher pressure to the other storage arrangement with the lower pressure. Accordingly, part of the gas compression work in a storage arrangement is therefore transferred as compression work to the other storage arrangement, and is therefore not lost. This causes a corresponding increase in the degree of efficiency of the heat engine. It is additionally possible to couple the two movable piston arrangements in such a way that a first partial cycle of the thermodynamic cycle runs in one storage arrangement and the other part in the other storage arrangement. The working gas can thereby in one storage arrangement reach the maximum pressure and at the same time the minimum pressure in the cycle in the other storage arrangement, so that pressure equalization can occur at a maximum pressure difference. An even higher degree of efficiency can thereby be obtained.

The heat engine can be an internal combustion engine or a hot air engine. The warm chambers can be configured such that they are supplied heat from an external heat source. The cold chambers can be configured such that heat can be transferred therefrom to an external storage or to the environment. The two storage arrangements can be configured as cylinders in each of which the movable piston arrangements run. In other words, the storage arrangements can be tubular in which in particular the piston arrangements run with a linear motion. The first and the second storage arrangement can be configured in an identical manner. The first and the second movable piston arrangement can be mechanically coupled to each other. The working gas can comprise monatomic or diatomic gas, and can in particular be a gas mixture. The static pressure of the gas can be variable in a range from 2 to 150 bar. The working gas can in particular be air.

The temperature difference between the warm and the cold chamber of a respective storage arrangement can preferably be located in a range of 1 K to 1000 K, in particular in a range from 10 K to 300 K, in particular in a range from 50 K to 150 K. The heat engine can be configured such that the working gas is in the two storage arrangements enclosed hermetically.

The connection of the two storage arrangements can in particular be configured such that exchange of a part quantity of the working gas flows from the warm chamber of the one storage arrangement to the cold chamber of the second storage arrangement. It is thereby achieved that part of the heat already present in the one storage arrangement is transferred to the other storage arrangement.

Still more advantageously, the connection of the two storage arrangements can be configured such that the volume of the warm chamber of the one storage arrangement and that of the cold chamber of the other storage arrangement is during exchange of a part quantity of the working gas at a maximum.

The first and the second storage arrangement can advantageous be configured as a first and a second displacement cylinder.

In other words, at least one storage arrangement can comprises a piston arrangement with a displacement piston and be configured such that the overall volume of the storage arrangement does not change during a movement of the displacement piston. The piston arrangement can be configured such that it divides the storage arrangement into the cold and the warm chamber.

The connection between the two storage arrangements can comprise a working cylinder which is in particular adapted to change the overall volume of the two storage arrangements. By having the connection be configured as a working cylinder, the first and the second storage arrangement can be configured as displacement cylinders. The working cylinder can be configured such that it changes the overall volume of both storage arrangements simultaneously. On the one hand, this causes the working cylinder to the change the overall volume of the two storage arrangements and the displacement pistons to press the working gas to and fro between the two chambers. This allows for a respectively simple implementation of the mechanism of the heat engine.

In a further advantageous embodiment, the displacement cylinders and the working cylinders can be arranged on a common axis. This results in a particularly simple configuration of the heat engine.

The two piston arrangements can comprise a piston rod on which one working piston and two displacement pistons are arranged. The working piston can there run within the working cylinder and the two displacement pistons within the respective displacement cylinders. Having both the working piston as well as the two displacement pistons be arranged on one piston rod results in a particularly simple construction of the piston arrangements.

The two storage arrangements can comprise a heater and a radiator that are adapted to supply thermal energy to or withdraw it from the working gas, respectively. The heater and the radiator of a storage arrangement can be arranged in a region of the warm or the cold chamber, respectively. Having the two storage arrangements each comprise a heater and a radiator achieves more efficient exchange with the working gas, since the heat does not need to be supplied to or withdrawn from the working gas via housing parts.

The radiator and/or the heater can be arranged such that the working gas passes through them when being exchanged between the cold and the warm chamber. The heater and/or the radiator can comprise a lamellar structure that allows for efficient heat exchange with the working gas.

In particular a regenerator can be respectively disposed between the heater and the radiator and be adapted to store heat from the working gas. By this arrangement, a portion of the heat can be withdrawn from the warm working gas via the regenerator and later again be supplied to the cold working gas. The degree of efficiency of the heat engine can thereby be further increased. The regenerator can be configured such that it supplies heat to or withdraws it from the working gas when the working gas is pressed to and fro between the warm and the cold chamber. The regenerator can have a lamellar structure.

The warm chamber can be divided into two partial chambers that are connected to each other via a connection channel. At least one storage arrangement can be configured such that a displacement piston, a cold chamber, a heater, a regenerator and/or a radiator is disposed in a cylinder between the first and the second partial chamber. The second partial chamber can be connected to the working cylinder.

The heat engine can comprise a flywheel and/or a spring, which is in particular connected to the first and/or the second piston arrangement. The flywheel and/or the spring can be adapted to buffer part of the work performed by the first and/or the second storage arrangement and to later return it to the storage arrangement. The flywheel and/or the spring can be connected to the piston rod. Synchronization of the heat engine can with this arrangement be improved.

The invention further provides a thermodynamic cycle for a heat engine, according to which a volume V₁ of a working gas having a mass m₁+Δm, starting out from a temperature T₁₁ and an equalization pressure pₘ, is in a work cycle during a first process step in a first storage arrangement expanded and heated to a volume V₁+ΔV₁ such that thereafter, the temperature T₁₂ is greater than T₁₁, and the pressure p₂ is greater than the equalization pressure pₘ, and a volume V₂+ΔV₂ of a working gas having a mass m₂, starting out from a temperature T₂₂ and an equalization pressure pₘ, is during a second process step in a second storage arrangement compressed and cooled to a volume V₂ such that thereafter, the temperature T₂₁ is smaller than T₂₂, and the pressure p₁ is smaller than the equalization pressure pₘ, and a compression occurs in the first storage arrangement and an expansion in the second storage arrangement during a third process step such that the same equalization pressure pₘ of the working gas is thereafter given in both storage arrangements, where the two storage arrangements are there preferably connected to each other such that a mass Δm of the working gas is exchanged between two storage arrangements

The first and the second process step can there run simultaneously.

A volume V₁+ΔV₁ of a working gas having the mass m₁ can in a further work cycle during a fourth process step in the first storage arrangement, starting out from a temperature T₁₂ and the equalization pressure pₘ be compressed and cooled to a volume V₁ such that thereafter the temperature T₁₁ is smaller than T₁₂ and the pressure p₁₁ is smaller than the equalization pressure pₘ. A volume V₂ of a working gas having a mass m₂+Δm can in a fifth process step in a second storage arrangement, starting out from a temperature T₂₁ and an equalization pressure pₘ, be expanded and heated to a volume V₂+V₂ such that thereafter, the temperature T₂₂ is greater than T₂₁, and the pressure p₂₂ is greater than the equalization pressure pₘ. During a sixth process step, an expansion in the first storage arrangement and a compression in the second storage arrangement can occur such that thereafter the same equalization pressure pₘ of the working gas is given in both storage arrangements, where preferably the two storage arrangements are there connected to each other such that a mass Δm of the working gas is exchanged between the two storage arrangements. The fourth and the fifth process step can there run simultaneously.

If no exchange of a mass Δm occurs between two storage arrangements, then the compression takes place entirely mechanically. In particular the mass of the working gas is there equal in both storage arrangements.

It can there be true that T₁=T₁₁=T₂₁, T₂=T₁₂=T₂₂, V==V₂ and ΔV=ΔV₁=ΔV₂. It can there likewise be true that p₁₁, =p₁ and/or p₂₂=p₂.

The heat engine can be connected to a solar system comprising in particular solar panels for converting solar energy into heat. The heat engine can be provided to generate useful work from the waste heat of a second heat engine.

Further features and advantages of the invention shall be explained below with reference to embodiments illustrated in the Figures, in which:

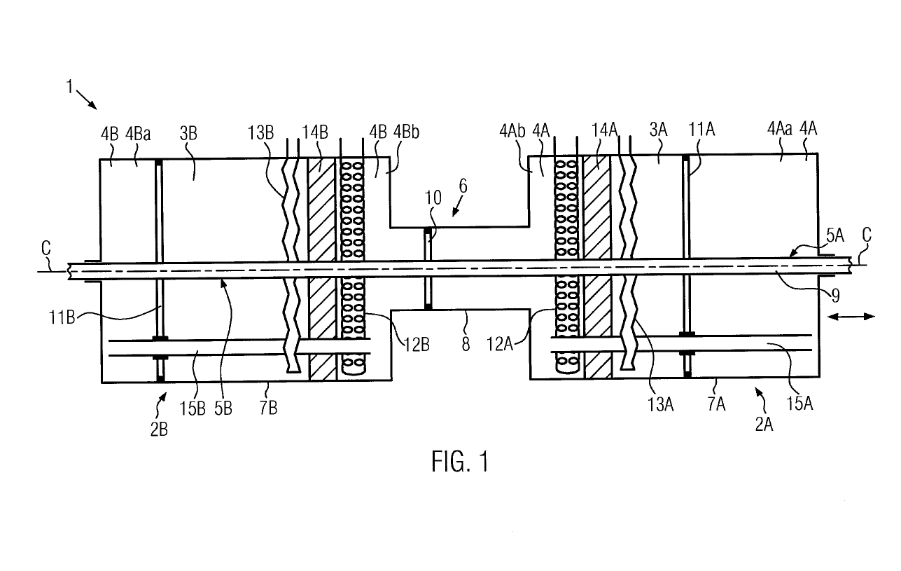

FIG. 1 shows a schematic representation of a heat engine according to the invention in a lateral view;

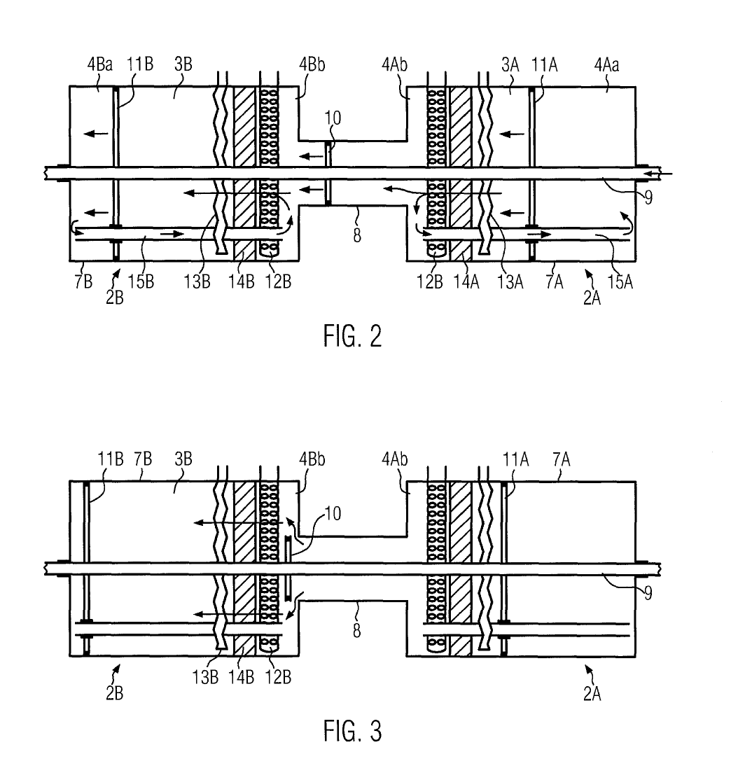

FIG. 2 in a schematic representation of the heat engine of FIG. 1 during the process steps 1 and 2 of the thermodynamic cycle;

FIG. 3 in a schematic representation of the heat engine of FIG. 1 during process step 3 of the thermodynamic cycle;

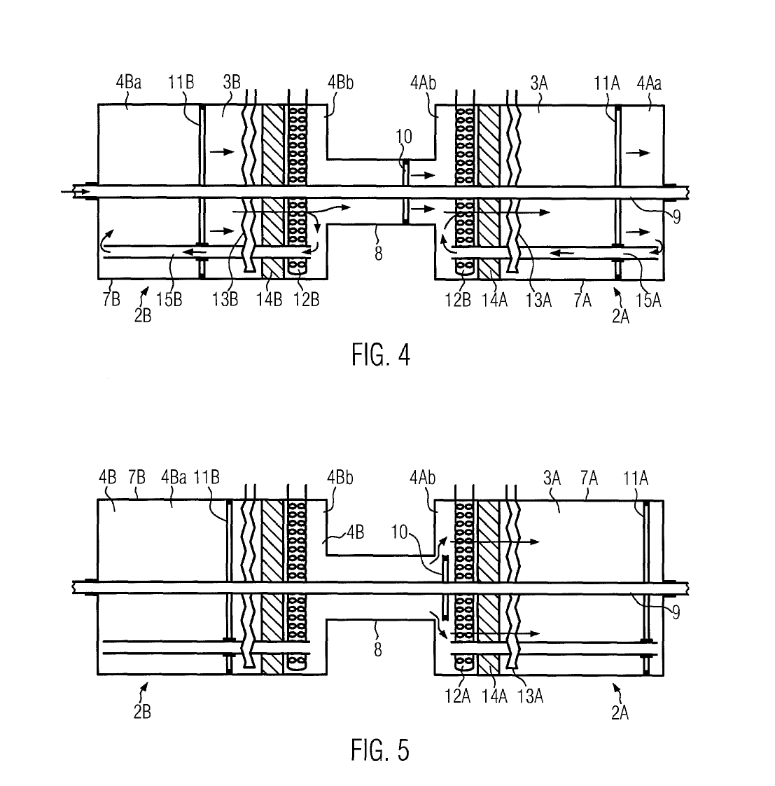

FIG. 4 in a schematic representation of the heat engine of FIG. 1 during process steps 4 and 5 of a further cycle of the thermodynamic cycle;

FIG. 5 in a schematic representation of the heat engine of FIG. 1 during process step 6 of a further cycle of the thermodynamic cycle; and

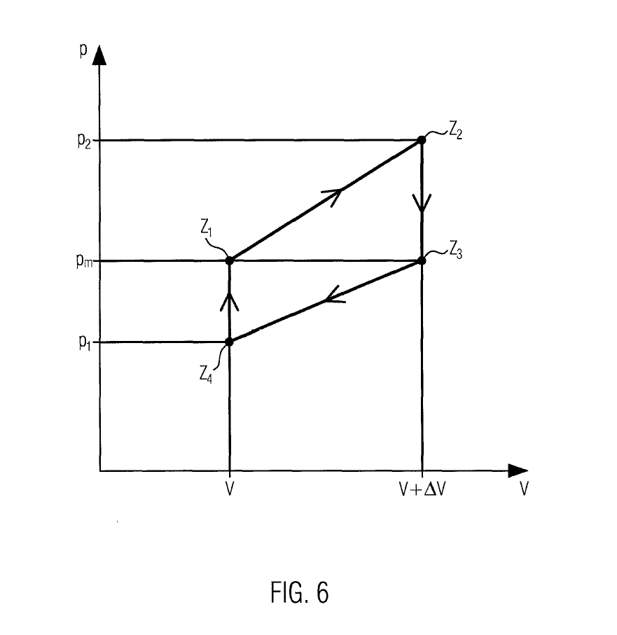

FIG. 6 in a p-V diagram shows a cycle of thermodynamic cycle.

FIG. 1 shows a schematic representation of a heat engine according to the invention in a lateral view. A first storage arrangement 2A for a working gas is shown there and it is divided into a first cold chamber 3A and a first warm chamber 4A. The division is there performed over the first movable piston arrangement 5A. In mirror symmetry thereto is a second storage arrangement 2B which is divided into the second cold chamber 3B and the second warm chamber 4B by a second movable piston arrangement 5B. The two storage arrangements 2A, 2B are connected to each other via a connection 6 so that a part quantity of the working gas can during two constellations of the piston arrangements 5A 5B be exchanged between the two storage arrangements 2A, 2B.

The two storage arrangements 2A, 2B are configured as displacement cylinders 7A, 7B, having a circular cross-section and are each divided into a warm chamber 4A, 4B and a cold chamber 3A, 3B. The division is there realized by the piston arrangement 5A, 5B, where the two displacement pistons 11A and 11B are located on a common piston rod 9. The piston rod 9 there moves to and fro on the axis C-C. The storage arrangements 2A, 2B each further comprise a heater 12A, 12B, a regenerator 14A, 14B and a radiator 13A, 13B. The working gas can with the heaters 12A, 12B be supplied heat originating from an external heat source. This is, for example, a solar energy system providing warm water that is pumped through the heaters 12A, 12B. The radiators 13A, 13B are configured such that heat can therewith be withdrawn from the working gas and discharged to the exterior. This is done, for example, by a cooling water circuit which flows through the radiators 13A, 13B. A regenerator 14A, 14B is disposed between the heater 12A, 12B and the radiator 13A, 13B and is presently made of copper wire mesh and can thereby buffer heat from the working gas when it passes through.

It can further be seen that the warm chambers 4A, 4B are divided into two respective partial chambers 4Aa, 4Ab, 4Ba, 4Bb which are connected to each other via the connection channels 15A, 15B. The working gas can therefore with a movement of the displacement piston 11A, 11B travel from the cold chamber 3A, 3B through the radiator 13A, 13B, the regenerator 14A, 14B, the heater 12A, 12B, into the one warm partial chamber 4Ab, 4Bb and from there through the connection channel 15A, 15B into the other partial chamber 4Aa, 4Ba This process can also occur vice versa.

The connection 6 is located between the two storage arrangements 2A, 2B and is configured as a working cylinder 8. A working piston 10 runs in this working cylinder 8 and is also fixedly connected to the piston rod 9. The overall volume of the storage arrangement 2A, 2B is thereby changed by the movement of the working piston 10. When the working piston 10 in FIG. 1 moves to the left, the volume of the first storage arrangement 2A is enlarged and that of the second storage arrangement 2B is reduced, respectively. Conversely, when the working piston 10 moves to the right, the volume of the first storage arrangement 2A is reduced and that of storage arrangement 2B is enlarged, respectively.

The piston rod is connected to a crankshaft on which a flywheel is mounted (presently not shown) which can buffer a portion of the work performed by the working gas.

How exactly the heat engine operates and how the movement of the working gas is within the displacement pistons 7A, 7B and the working piston, is explained in detail with reference to the subsequent four figures.

The heat engine according to FIG. 1 is shown schematically in FIG. 2 during process steps 1 and 2 of the thermodynamic cycle, where the piston rod 9 in FIG. 2 moves to the left. It can be seen that the displacement piston 11A within the displacement cylinder 7A likewise moves to the left, whereby the volume of the cold chamber 3A is reduced. The working gas is thereby pushed through the radiator 13A, the regenerator 14A and the heater 12A and the working gas is then heated and passes from there into the partial chamber 4Ab downstream of the heater. A portion of the working gas flows from there through the connection channel 15A back into the second partial chamber 4Aa. Heated working gas is therefore present also in the second partial chamber 4Aa. Similarly, the working piston 10 with the piston rod 9 moves to the left and the overall volume of the first storage arrangement 2A is enlarged accordingly. Heated working gas is therefore also present in the working cylinder 8 in a region to the right adjacent to the working piston 10.

With the illustrated process step of the thermodynamic cycle, the volume V of the working gas with the mass m+Δm is therefore in the first storage arrangement 2A enlarged and the temperature is increased from T₁ to T₂. The temperature increase is there selected such that the pressure of the working gas rises from pₘ to p₂. This causes a force to act upon the working piston 10 whereby the actual useful work is performed by the working gas and can be discharged via the working piston 10.

In the second storage arrangement 2B, the displacement piston 11B in the displacement cylinder 7B likewise moves to the left as it is likewise fixedly connected to the piston rod 9. The volume of the warm partial chamber 4Ba is thereby reduced and the working gas is pressed through the connection channel 15B into the second warm partial chamber 4Bb. The working gas is then pressed through the heater 12B, the regenerator 14B and the radiator 13B and thereby cooled, where it subsequently passes into the cold chamber 3B. The overall volume of the storage arrangement 2B is at the same time reduced due to the movement of the working piston 10 in FIG. 2 towards the left.

The working gas with the mass m in the second storage arrangement 2B is thereby cooled down from temperature T₂ to the lower temperature T₁, and the volume is at the same time compressed from V+V Δ to V. At the same time, the working gas is cooled to such a degree that the pressure drops to a lower pressure p₂.

Shortly before the pistons 11A, 10, 11B have reached their extreme position in FIG. 2 at the left, a partial mass m+Δm with the high temperature T₂, the high pressure p₂ and the larger volume V+ΔV is therefore located in the first storage arrangement 2A. A part quantity of the working gas with mass m, the low temperature T₁, the low pressure p₁ and the smaller volume V is located in the second storage arrangement 2B.

FIG. 3 schematically shows the heat engine according to FIG. 1 during process step 3 of the thermodynamic cycle, where the piston rod 9 is now in the extreme left position. It can be seen that the working piston 10 has now moved out from the working cylinder 8 to a degree that an open connection exists between the two storage arrangements 2A, 2B. After the working gas in the first storage arrangement 2A previously had a higher pressure than in the second storage arrangement 2B, pressure equalization between the two storage arrangements 2A, 2B now occurs, so that a mean pressure pₘ arises. A portion of the warm working gas with the mass Δm and the temperature T₂ thereby passes from the first storage arrangement 2A into the second storage arrangement 2B and flows through the heater 12B, the regenerator 14B and the radiator 13B into the cold chamber 3B. Accordingly, this part quantity Δm of the working gas is cooled down to temperature T₁. The corresponding gas compression work q1 is transferred from the first storage arrangement 2A to the second storage arrangement 2B. The gas compression work q1 is calculated using the formula q1=T₂×Δm. A part thereof is performed by the compression work q2=T₁×Δm in the second storage arrangement in order to there compress the part quantity Δm of the working gas.

FIG. 4 schematically shows the heat engine according to FIG. 1 during process steps 4 and 5 of a further cycle of the thermodynamic cycle, where the change of state there occurs converse to FIG. 2. It can there be seen that the piston rod 9 moves to the right, and therefore also the two displacement pistons 11A, 11B as well as the working piston 10.

Due to the fact that the displacement piston 11A in the first storage arrangement 2A moves to the right, the volume of the warm partial chamber 4Aa is reduced and the working gas contained therein is pressed through the connection channel 15A into the second partial chamber 4Ab and from there through the heater 12A, the regenerator 14A and the radiator 13A into the cold chamber 3A. The working gas is there cooled down accordingly. The overall volume of the first storage arrangement 2A is at the same time reduced due to the movement of the working piston 10 in the working cylinder 8, whereby the working gas is further compressed.

The working gas with the mass m is thereby in the first storage arrangement 2A after the change of state cooled down to the lower temperature T₁, and the volume V+ΔV is there compressed to V. The pressure is in this change of state reduced from the mean pressure pₘ to the lower pressure p₁.

The working gas is at the same time in the second storage arrangement 2B in the displacement cylinder 7B by the movement of the displacement piston 11B pressed to the right from the cold chamber 3B through the radiator 13B, the regenerator 14B and the heater 12B into the partial chamber 4Bb and thereby heated. Then it passes through the connection channel 15B into the second warm partial chamber 4Ba. The overall volume of the second storage arrangement 2B is at the same time enlarged due to the movement of the working piston 10 in the working cylinder 8.

The working gas with the mass m+Δm in the second storage arrangement 2B after the change of state has the higher temperature T₂, the larger volume V+ΔV and the higher pressure p₂.

FIG. 5 illustrates the heat engine of FIG. 1 during process step 6 of a further cycle of the thermodynamic cycle. It can there be seen that the pistons 11A, 10, 11B are located in the rightmost position. The volume of the cold chamber 3A in the first storage arrangement 2A and the volume of the warm chamber 4B in the second storage arrangement 2B are at a maximum. The working piston at the same time moves out from the working cylinder to such a degree that an open connection arises between the two storage arrangements 2A, 2B.

Pressure equalization is there again obtained between the two storage arrangements 2A, 2B and a part quantity of the working gas with the mass Δm flows from the second storage arrangement with the higher pressure p₂ into the first storage arrangement 2A with the lower pressure p₁. The working gas there flows past the working piston through the heater 12A and the regenerator 14A and the radiator 13A into the colder chamber 3A and is thereby cooled. The gas impression work q1=T₂×Δm is thereby transferred from the second storage arrangement 2B to the first storage arrangement 2A and there performs the compression work q2=T₁×Δm. After pressure equalization has occurred, the mean pressure pₘ prevails in both storage arrangements 2A, 2B.

FIG. 6 shows a p-V diagram of a cycle of the thermodynamic cycle in which the changes of state of FIGS. 2 and 3 are summarized. A diagram is shown in which the volume is plotted on the abscissa and the pressure on the ordinate.

A quantity of the working gas m+Δm is first located in the first storage arrangement 2A and has the state Z₁. The working gas there has the mean pressure pₘ, the volume V and the temperature T₁. After the enlargement of the overall volume of the storage arrangement 2A by the movement of the working piston 6, the working gas now reaches the volume V+VA and is at the same time heated to temperature T₂. As a consequence, a higher pressure of the working gas p₂ results and the working gas is therefore in the state Z₂

At the same time, a change of state occurs in the second storage arrangement 2B of the working gas with the mass m from state Z₃ to state Z₄. A reduction of the overall volume of the second storage arrangement 2B arises from V+ΔV to V due to the movement of the working piston 8 in the working cylinder 10. At the same time the working gas is cooled to the lower temperature T₁, and after the change of state therefore has a lower pressure p₁.

After the working gas now in the first storage arrangement is in state Z₂ and in the second storage arrangement 2B in state Z₄, pressure equalization occurs between the two storage arrangements 2A, 2B to the mean pressure pₘ, where the working gas in the first storage arrangement 2A is now in state Z₃ and in the second storage arrangement 2B in state Z₁. The mass Δm of the working gas is there now transferred from the first storage arrangement 2A to the second storage arrangement 2B.

FIG. 6 therefore shows a complete work cycle of the heat engine according to the invention. It is in the repeated in the subsequent work cycle. However, the two storage arrangements are at the beginning of the work cycle in respectively complementary states Z₁ and Z₃, respectively. The piston rod during one cycle moves from one extreme position to the other extreme position, more precisely in FIG. 1 from the left to the right or from the right to the left. In FIG. 1, the piston rod is connected to a crankshaft which during one work cycle moves by a crank angle of 180°.

1. Heat engine for converting heat into useful work, comprising:
a first storage arrangement for a working gas, where it is divided into a first cold and a first warm chamber, and
a first movable piston arrangement is configured such that it changes the overall volume of said first storage arrangement and presses said working gas to and fro between said two first chambers,
wherein
said heat engine comprises a second storage arrangement for said working gas, where the latter is divided into a second cold and a second warm chamber, and
a second movable piston arrangement is configured in such a way that it changes the overall volume of said second storage arrangement and presses said working gas to and fro between said two second chambers, and that
a connection between said first and said second storage arrangement is provided for a part quantity of said working gas to be exchanged between said two storage arrangements at least during a predefined constellation of said two piston arrangements.

2. Heat engine for converting heat to useful work according to claim 1, wherein said connection of said two storage arrangements is configured such that a part quantity of said working gas during said exchange flows from said warm chamber of said one storage arrangement to said cold chamber of said other storage arrangement.

3. Heat engine for converting heat to useful work according to claim 1, wherein said first and said second storage arrangement are configured as a first and a second displacement cylinder.

4. Heat engine for converting heat to useful work according to claim 1, wherein said connection between said storage arrangements comprises a working cylinder which is in particular adapted to change the overall volume of said two storage arrangements.

5. Heat engine for converting heat to useful work according to claim 3, wherein said displacement cylinders and said working cylinder are disposed on a common axis.

6. Heat engine for converting heat to useful work according to claim 1, wherein said two piston arrangements comprise a piston rod on which a working piston and two displacement pistons are disposed.

7. Heat engine for converting heat to useful work according to claim 1, wherein said two storage arrangements each comprise a heater and a radiator which are adapted to supply thermal energy to or dissipate it from said working gas.

8. Heat engine for converting heat to useful work according to claim 7, wherein said radiator and/or said heater are arranged such that said working gas passes through them when being exchanged between said cold and said warm chamber.

9. Heat engine for converting heat to useful work according to claim 7, wherein a regenerator is respectively disposed between said heater and said radiator and is adapted to store heat from said working gas.

10. Heat engine for converting heat to useful work according to claim 1, wherein said warm chamber is divided into two partial chambers which are connected to each other via a connection channel.

11. Heat engine for converting heat to useful work according to claim 1, wherein said heat engine comprises a flywheel and/or a spring which is in particular connected to said first and/or said second piston arrangement.

12. Thermodynamic cycle for a heat engine, wherein in one cycle
(1) a volume V₁ of a working gas having the mass m₁+Δm in a first storage arrangement, starting out from a temperature T₁₁ and an equalization pressure pₘ, is expanded and heated to a volume V₁+ΔV₁ such that thereafter the temperature T₁₂ is greater than T₁₁ and the pressure p₂ is greater than said equalization pressure pₘ, and
(2) a volume V₂+ΔV₂ of a working gas having the mass m₂ in a second storage arrangement, starting out from a temperature T₂₂ and the equalization pressure pₘ, is compressed and cooled to a volume V₂ such that thereafter the temperature T₂₁ is smaller than T₂₂ and the pressure p₁ is smaller than the equalization pressure pₘ, and
(3) an expansion in said first storage arrangement and a compression in said second storage arrangement occurs such that thereafter the same equalization pressure pₘ of said working gas is given in both storage arrangements, where preferably said two storage arrangements are there connected to each other such that a mass Δm of said working gas is exchanged between said two storage arrangements.

13. Thermodynamic cycle for a heat engine according to claim 12, wherein the process steps (1) and (2) run simultaneously.

14. Thermodynamic cycle for a heat engine according to claim 12, wherein it is true that T₁=T₁₁=T₂₁, T₂=T₁₂=T₂₂, V=V₁=V₂ and ΔV=ΔV₁=ΔV₂.

15. A heat engine using a working gas for converting heat into useful work comprising:
a first displacement cylinder;
a first displacement piston placed within said first displacement cylinder, said first displacement piston dividing said first displacement cylinder into a first cold chamber and a first warm chamber;
a first connection channel placed between the first cold chamber and the first warm chamber;
a second displacement cylinder;
a second displacement piston placed within said second displacement cylinder, said second displacement piston dividing said second displacement cylinder into a second cold chamber and a second warm chamber;
a second connection channel placed between the second cold chamber and the second warm chamber;
a working cylinder placed between said first displacement cylinder and said second displacement cylinder, said working cylinder coupling said first displacement cylinder and said second displacement cylinder together;
a working piston placed within said working cylinder;
a common piston rod having an axis coupling said first displacement piston, said second displacement piston, and said working piston together;
first means, coupled to said first displacement cylinder, for selectively heating and cooling the working gas; and
second means, coupled to said second displacement cylinder, for selectively heating and cooling the working gas,
whereby said working piston and said common piston rod are cyclically moved along the axis towards and away from said first displacement cylinder and said second displacement cylinder generating useful work.
